(19) United States
(12) Patent Application Publication
(10) Pub. No.: US 2012/0156650 A1
(43) Pub. Date: Jun. 21, 2012

(54) Dental crown and a method of fabricating and installing such a dental crown in one patient visit

(75) Inventors: James R. Glidewell, Newport Beach, CA (US); Robin A. Carden, San Juan Capistrano, CA (US); Wolfgang Friebauer, Costa Mesa, CA (US)

(73) Assignee: James R. Glidewell Dental Ceramics, Inc.

(21) Appl. No.: 13/374,039

(22) Filed: Dec. 8, 2011

Related U.S. Application Data
(60) Provisional application No. 61/459,722, filed on Dec. 17, 2010.

(51) Int. Cl. A61C 5/11; A61C 5/10

(52) U.S. Cl. 433/219; 433/223

(57) ABSTRACT

A process to make/seat a permanent crown in only one patient visit, without the need for a temporary crown, after a digital scan or other impression has been taken prior during a dental cleaning appointment or status check up. The dental information is filed and can be used whenever the patient needs a dental restoration to be made. The impression information will have previously been forwarded to a dental laboratory where a shell-crown can be made that is a perfect match to the outer contour of the existing tooth. Needed improvements/corrections can be made with the use of digital software. Also the margins can be determined and corrected, even in the inter-proximal spaces. Now the laboratory is able to manufacture and provide a finished shell-crown in time for the following doctor appointment of this patient.

### CROSS-REFERENCE TO RELATED APPLICATIONS

This application takes priority from provisional application Ser. No. 61/459,722, filed on Dec. 17, 2010.

### BACKGROUND OF THE INVENTION

1. Field of the Invention

The present invention relates generally to the field of dentistry and more specifically to the fabrication and installation of a restorative dental crown without requiring a temporary crown or a second patient visit for any particular tooth reconstruction.

2. Background Discussion

The present invention relates to fabricating a restoration outside of the mouth using the dental impressions of the prepared tooth. Usually a dental technician fabricates the indirect restoration from records of the prepared tooth the dentist has provided. The finished restoration is usually bonded permanently with a dental cement. It is often done in two separate visits to the dentist.

While the indirect restoration is being prepared, a provisory/temporary restoration is used to cover the prepared part of the tooth, and thereby help maintain the surrounding dental tissues.

When an individual needs a tooth restoration, a cosmetic dentist/technician may recommend that they receive a porcelain-fused-to-metal crown (also known as a PFM crown). A porcelain-fused-to-metal crown is constructed out of a metal core that is surrounded by a layer of baked porcelain fused to the metal.

Any number of reasons exist why a dentist may recommend a PFM crown. One reason is that the dentist may need to repair a previously filled tooth that has lost its dental filling. This tooth will require repair, and a crown is an excellent way to save the tooth, protect it from future decay, and restore its full functionality.

Getting fitted with a porcelain-fused-to-metal crown, always takes a patient more than one trip to the dentist because it involves a number of preparatory steps and the assistance of a special dental laboratory dedicated to the custom manufacture of various cosmetic dental restorations, including dental crowns. Most of the time, if all goes as planned, a patient will be fitted with a crown in two appointments.

The first appointment focuses on preparation. The dentist begins by numbing the area that surrounds the tooth. The dentist also places a rubber dam in the back of the mouth to protect the throat from dental debris. Next, he or she uses a dental hand-piece to remove any decay away from the tooth and shapes it at the same time into a surface that will effectively wear the crown.

Once this process is completed, an impression of the teeth is made. Using this impression, the dentist will make a model of the teeth. This model is then sent to the dental lab. Before sending the patient home, the dentist completes the first visit by fitting the patient with a temporary crown that will protect the tooth during the interim between office visits.

Once the permanent crown is completed by the dental laboratory and sent to the dentist's office, the patient returns for a second visit. During this second visit, the temporary crown is removed, the prepped tooth is treated with an antiseptic and the new crown is cemented onto the prepped tooth, usually using a UV curable cement.

### SUMMARY OF THE INVENTION

The invention herein relates to a process to make/seat a permanent crown in only one patient visit, without the need for a temporary crown, after a digital scan or other impression has been taken prior during a dental cleaning appointment or status check up. The dental information is filed and can be used whenever the patient needs a dental restoration to be made.

During a cleaning appointment or status check, the doctor discovers the need for a crown emplacement due to a defect on the oral tooth structure. Impression information will have previously been forwarded to a dental laboratory where a shell-crown can be made that is a perfect match to the outer contour of the existing tooth. Needed improvements/corrections can be made with the use of digital software. Also the margins can be determined and corrected, even in the inter-proximal spaces. The thickness of this crown can be selected to be anywhere from 0.3-2.0 mm. Now the laboratory is able to manufacture and provide a finished shell-crown in time for the following doctor appointment of this patient. The doctor is able to prep the tooth, quick check the fit of the delivered shell-crown and can then seat this crown with a special (zirconia filled) cement, which is used to fill in the space between the crown shell and prepped tooth-structure. A light induced cure cement with a specialty ceramic filler component (for example alumina, zirconia or quartz and other glasses) can be used for this shell-crown seating. After the reline and seating procedure, an additional step may be needed to trim the margins and cement the crown in place permanently. Strength of the restoration is not an issue due to the filled cement and strength of the shell ceramic crown. The patient can leave the doctor's office without the need for a temporary crown and without a second appointment for this particular tooth reconstruction.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a cross-sectional view of a first example of a crown fabricated and seated into a patient's mouth in accordance with the present invention; and

FIG. 2 is a cross-sectional view of a second example of such a crown.

### DETAILED DESCRIPTION OF A PREFERRED EMBODIMENT

Referring to the accompanying drawings, it will be seen that the result of the method of the present invention comprises what is referred to therein as a shell-crown. Such a crown consists of a thin ceramic crown layer made of zirconia in one embodiment. The entire volume between this thin crown upper surface layer and a prepared tooth being covered by the crown, is a volume of UV curable relining cement which is flowable during seating and which hardens with curing.

The shell-crown has a thickness that is preferably in the range of 0.3 to 2.0 mm. The reline cement is homogeneously infiltrated with zirconia. A seating cement also uses zirconia, but other ceramic filler, such as materials made of alumina or quartz may also be used. After the relining cement hardens from UV curing, the resulting crown, including the shell covered cement, comprises a hard, durable ceramic crown that is then firmly engaged with the underlying prepped tooth with a seating cement and is indistinguishable from the original tooth.

The process of the present invention starts with a digital scan of the patient's full mouth dental structure. This digital scan is preferably obtained during a previous visit to the dentist's office such as for cleaning or ordinary checkup. The resulting digital image is then stored for future use, such as in the digital memory files of a dentist's computer. From time to time, over a period of years, the digital image may be updated to reflect the patient's changing dental structure.

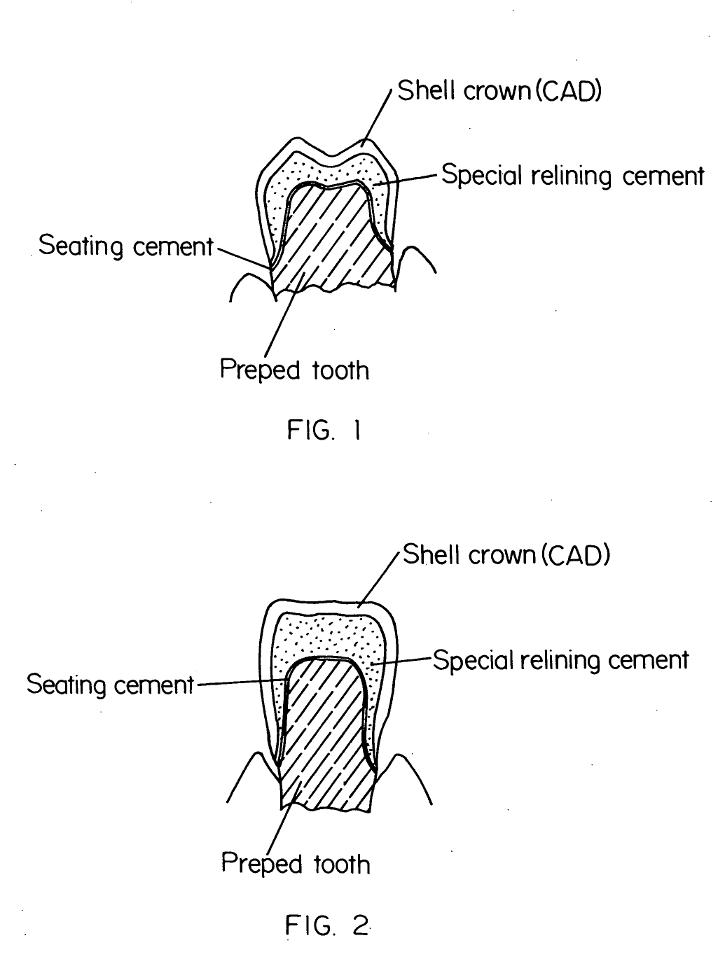

If and when that patient may require that a crown be used to protect a tooth that has been injured or has otherwise become structurally defective, the dentist can electronically forward the stored digital image data to a laboratory where the shell-crown of FIGS. 1 and 2, can be made to precisely replicate the outer contour of the original tooth that needs to receive a crown. Corrections that may be needed can be accomplished digitally in the software. The finished shell crown is then shipped to the dentist for the patient's first and only needed visit to install a crown. The faulty tooth is prepped, the shell-crown is filled with the aforementioned curable ceramic reline cement and seated onto the prepped tooth. After the reline cement is seated and cured, the combined shell-crown and reline cement are secured to the prepped tooth with a curable seating cement that would be used with any type crown.

Using this process, the permanent crown is fully fabricated and seated with just one patient visit and without requiring any form of temporary crown.

We claim:

1. A process for fabricating and seating a dental restorative crown while relying on only one patient visit specifically for the crown preparation; the process comprising the steps of:
storing a digital image of a patient's dental configuration obtained using a scanner during a cleaning or other dentist office visit;
when a need arises, sending the digital image to a laboratory;
fabricating a shell crown for a selected tooth based on said image and sending the shell crown to the dentist;
prepping the selected tooth for receiving a crown restoration;
filling said shell crown with a curable ceramic filled reline cement and seating said filled shell crown on said prepped tooth;
curing said reline cement and cementing said shell crown and cured reline cement onto said prepped tooth to form a permanent crown.

2. The process recited in claim 1 wherein the step of fabricating said shell crown comprises forming an outer contour of said selected tooth out of a ceramic material to a thickness of 0.3 mm to 2.0 mm.

3. The process recited in claim 2 wherein said ceramic material is zirconia.

4. A dental crown especially suited to installation in a process needing only one patient visit; the crown comprising:
a shell crown surface having a contour that substantially duplicates an existing tooth exterior; said shell crown surface having a maximum thickness up to about 2.0 mm;
a cement material occupying a space between the shell crown surface and a prepped form of said existing tooth wherein the cement material conforms to the contour of said shell crown surface along a first end of said crown and conforms to the contour of said prepped form of the existing tooth along a second end of said crown;
a light-induced cure material applied to said second end of said crown for securing it to said prepped form of said existing tooth.

5. The dental crown recited in claim 4 further comprising a digital representation of said existing tooth exterior which is duplicated by said shell crown surface.

6. The dental crown recited in claim 4 wherein said cement material comprises zirconia.

7. The dental crown recited in claim 4 wherein said shell crown surface comprises zirconia.

8. The dental crown recited in claim 4 wherein said shell crown surface has a minimum thickness of 0.3 mm.

9. The process recited in claim 1 wherein in said fabricating step, said shell crown is made of a ceramic material.

10. The process recited in claim 1 wherein is said fabricating step, said shell crown is made of predominantly zirconia.
